(19) United States
(12) Patent Application Publication
(10) Pub. No.: US 2023/0249901 A1
(43) Pub. Date: Aug. 10, 2023

(54) PLASTIC TANK WITH HIGH STRENGTH ENDWALL

(71) Applicant: Advanced Drainage Systems, Inc., Hilliard, OH (US)

(72) Inventors: Paul HOLBROOK, Old Saybrook, CT (US); Bryan COPPES, Old Saybrook, CT (US); Alexander SHAIN, Lyme, CT (US)

(73) Assignee: Advanced Drainage Systems, Inc., Hilliard, OH (US)

(21) Appl. No.: 18/165,539

(22) Filed: Feb. 7, 2023

Related U.S. Application Data
(60) Provisional application No. 63/307,575, filed on Feb. 7, 2022.

(51) Int. Cl. B65D 88/76

(52) U.S. Cl. CPC B65D 88/76

(57) ABSTRACT

A septic tank for storing and treating wastewater may be provided. In one implementation, a septic tank, having a first lengthwise end, an opposing second lengthwise end, a top, a bottom, a horizontal centerplane, and a vertical lengthwise centerplane, and a basic wall thickness T may be provided. The septic tank may include corrugated walls and an oblong flange lying nominally in the horizontal centerplane. The tank may further include opposing endwalls, each endwall integrally connecting an end of a first sidewall to an end of a second sidewall. The endwalls may include an endwall top, an endwall side running from the upper half tank flange to the endwall top along an inward slant, and the endwall side may along a curve which is a semicircle or a portion of a curve.

### CROSS REFERENCE TO RELATED APPLICATION

This application is based on and claims benefit of priority of U.S. Provisional Pa. Application No. 63/307,575, filed on Feb. 7, 2022. The content of the foregoing application is incorporated herein by reference in its entirety.

### TECHNICAL FIELD

The present invention relates to molded plastic tanks shaped for holding liquid when buried underground, in particular to septic tanks comprising mated half tanks for use in subsurface wastewater treatment.

### BACKGROUND

Septic tanks that are used for receiving and treating wastewater while buried underground have for many years been formed by mating concrete half-tanks at the site of use. In recent decades, evolving technology enabled molded plastic tanks which, for domestic and small commercial wastewater treatment typically hold between 500 and 1500 gallons. A common size is about 1000 gallons.

Early plastic tanks were made of thermoset resins, for example, fiberglass reinforced polyester resin. Half tanks are formed by laying up fiberglass mats and resin in molds and mating the half tanks. More recently, commercial favor has been given to lower cost septic tanks made of thermoplastics such as polyethylene or polypropylene. One-piece thermoplastic tanks have been made by rotational molding and blow molding. Those processes produce tanks which have varying wall thicknesses that are both hard to avoid and difficult to selectively situate. Two-piece septic tanks have been formed by producing injection molding half tanks and joining them to each other. Such tanks typically have controlled and typically uniform wall thicknesses because the process of forming thermoplastic half tanks provides rapid and uniform cooling in the mold and reduces local distortion compared to forming larger one piece tanks. In further comparison, the wall thickness of a “laid-up” fiberglass tank can be varied locally by selective addition of layers.

A disadvantage of one-piece tanks is the cost of shipping such bulky objects. When tanks are formed by mating injection molded half tank at a lengthwise joint, the half tanks can be efficiently stored and shipped in a nested condition. Near to, or at, the point of use, half tanks may be mated and secured to each by clamps or other fasteners.

Plastic septic tanks must have sufficient strength to maintain shape during handling, storage, installation, testing and use. On some occasions, tanks may be subjected to negative internal pressure as a way of determining the tank’s resistance to resist inward pushing force during use. During septic tank use, it is typical to have void/air space above the wastewater that is about 15% of the stated tank storage volume, and this void/air space volume is in addition to the stated tank storage volume. Thus, a typical tank rated for 1050 gallons (about 140 cubic feet) of storage may have an interior volume of about 160 cubic feet when accounting for the void/air space volume.

During use, a buried septic tank must resist the weight of overlying media and possible light vehicular traffic. The tank sides must resist any inward pressing of the surrounding media. Water within the tank tends to deform the tank outwardly and downwardly. Sometimes the underlying and surrounding media do not provide uniform support to the extent that, in a tank having internal vertical bracing, the outer ends can deform outwardly and downwardly. That deformation will tilt a top ring that circumscribes an access port in the top of the tank near the end. A riser attached to the ring often projects above the ground surface and the tilting of the ring due to deformation of the tank creates a poor impression. Tilting of the ring could suggest undue strain on the tank. Occasional maintenance may require that a tank be emptied, and inward forces on the tank sidewall will not be balanced by the weight of water within the tank when the tank is emptied for maintenance.

Large plastic tanks, including those suitable for septic tank applications, have been previously made as injection molded halves which are clamped together for use. Injection molding produces improved dimensional control and fidelity compared to other previously used production techniques.

Large plastic tanks have alternatively been made of thermoset polyester resin in combination with long glass fibers, particularly woven glass fiber mesh. Such tanks, often referred to as “fiberglass tanks,” have been formed by laying the glass fibers and resin on the surface of a male or female mold (a process known as “lay-up”). Lay-up may be completed manually or may be completed wholly or in part by a robotic system substituting for manual labor. By adding additional layers, the wall thickness may be varied to increase strength locally. And interior and exterior ribs may be formed. Likewise, for strength, fiber/mesh orientation may be varied locally.

In contrast, when large plastic tanks are formed in conventional practice by injection molding or compression molding of thermoplastics. such as polyethylene or polypropylene, tanks must have nearly the same wall thickness throughout, to avoid localized shrinkage and to expedite mass production. In such tanks, wall thickness will preferably be within about 5 to 10 percent of the component’s ‘basic thickness” - i.e., nominally, the average wall thickness. Occasionally, in local regions, the wall thickness of a septic tank may have a thickness which is 15 percent more or less than the basic thickness.

Thermoplastic tanks may also be formed by blow molding and rotational molding. The nature of those processes is to produce a tank with mostly a constant wall thickness, but there often will be localized thicker and thinner regions.

Typically, molded thermoplastic septic tanks are characterized by corrugated walls that are lightweight and provide strength. There are competing design objectives attending a two-piece molded thermoplastic septic tank. For example, a strong aim is to minimize the weight of plastic (and thus the cost) per unit of tank interior volume, which can be achieved by having thin but strong walls.

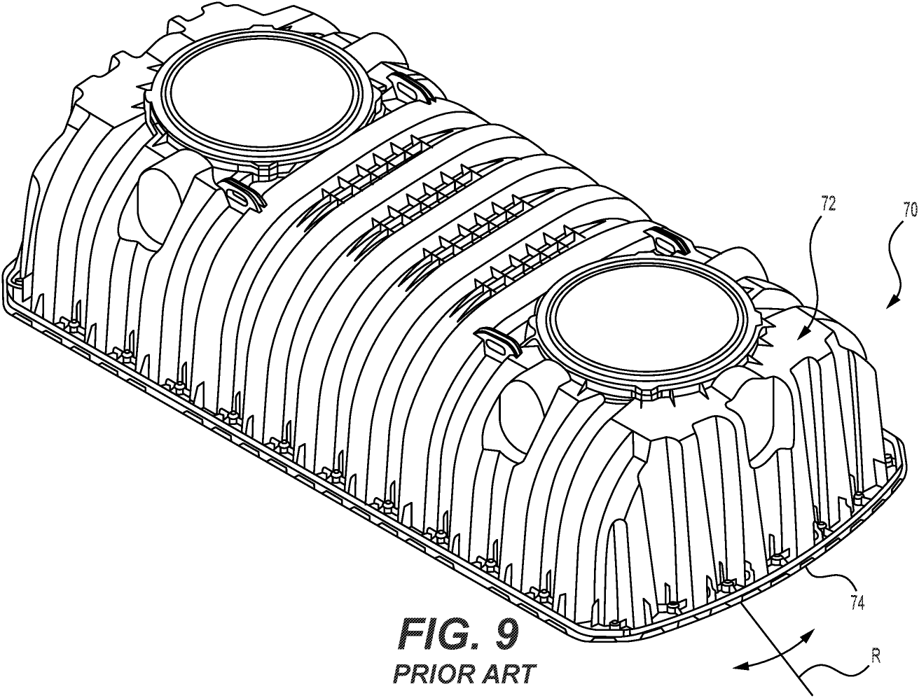

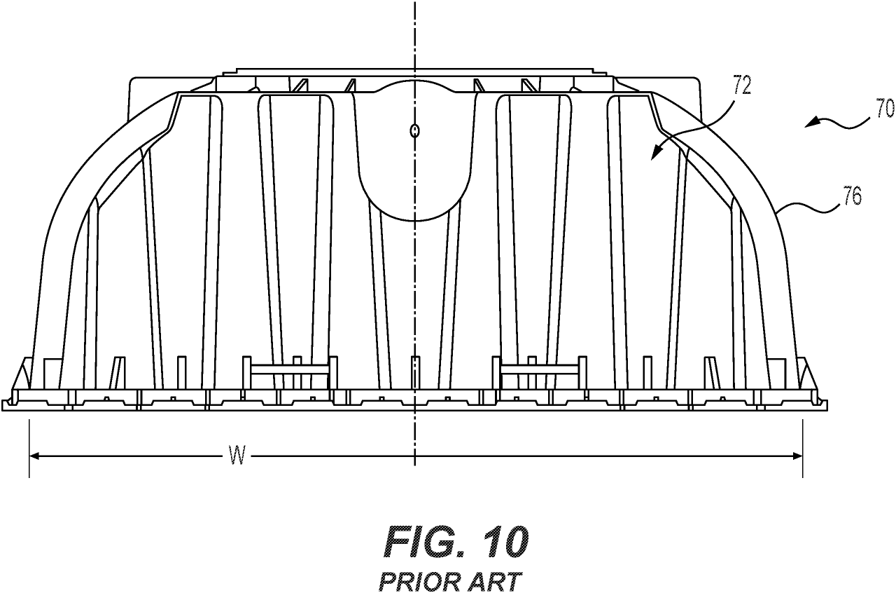

Another aim is to create a compact tank. Compact tanks may take the form of cubical or spherical shapes because those forms make efficient use of space. Another aim is to have a tank that may be used as a replacement for a familiar concrete septic tank. A typical commercial 1000-gallon concrete septic tank may be a rectanguloid having a length of about 96 inches, a width of about 62 inches, and a height of about 68 inches. Molded plastic commercial septic tanks with rounded edges and a rectanguloid shape that approximates typical concrete tank dimensions are known in the art. Such a tank may comprise mated half tanks as shown in FIGS. 9 and 10 in this application.

### SUMMARY

An object of the invention is to provide a thermoplastic septic tank that may be formed by joining together half tanks, resulting in improved strength while minimizing any increase in the amount of low cost commercially available plastic that is used to make the tank.

In one embodiment, a septic tank may be made of two half tanks, an upper half tank and a lower half tank. The two half tanks may be made of thermoplastic. The half tanks may be secured to each other by joint flanges lying in a horizontal centerplane of the tank. The half tanks may be nearly identical except that an access port opening may be included in the upper half tank and not the lower half tank. The half tanks may have corrugated walls.

In an embodiment of a tank, the upper half tank and the lower half tank may have a substantially flat top wall, a substantially flat bottom wall, opposing endwalls, and lengthwise-extending sidewalls that slope outwardly as they run from the top or bottom of the half tank to the joint flange. The endwalls may be substantially curved in a horizontal plane of the tank, and may be minimally or lightly curved in the vertical direction.

In another embodiment, the tank may be one-piece and may have substantially the same configuration as the two-piece tank, including having joint flanges that are integral with each other.

An upper half tank of a two-piece tank embodiment may have a joint flange and two opposing endwalls. Each endwall may be integral with all other components of the half tank. Each endwall may have a joint flange that is a portion of the half tank base flange, a top which merges with the top of the half tank, a side wall that (i) runs along an arc path between the vertical ends of the opposing sidewalls, (ii) runs from the endwall joint flange to the endwall top on a slope that pitches inward toward the tank interior, and (iii) has a nominal C shape in the horizontal plane, wherein the area within the C near the top of the endwall is smaller than the area within the C near the bottom of the endwall.

In an embodiment, an endwall may be curved in a horizontal plane of the upper half tank that is above the joint flange and below the endwall top. In another embodiment, the curve may be a semi-circle, i.e., it may have a radius that is half of the width W of the half tank, i.e., 0.5 W, which is the distance between the sidewalls at the elevation of the joint plane. In other embodiments, the radius may be between 0.5 W and 0.65 W.

In some embodiments, in the vertical direction the endwall of the upper half tank embodiment may slope inwardly. In some embodiments, the endwall of the upper half tank may slope inwardly at an angle of about 3 to about 9 degrees from the vertical axis. In one embodiment, the endwall of the upper half tank may slope inwardly at an angle of about 7 degrees. That angle of the side may match the shape of the sidewall ends or may blend into the sidewall when the sidewall has a different angle or contour.

In an embodiment of an upper half tank, the side of the endwall may run from the joint flange along the path of a segment of a regular conical frustum to an abrupt curve that characterizes the curved outer edge of the endwall top.

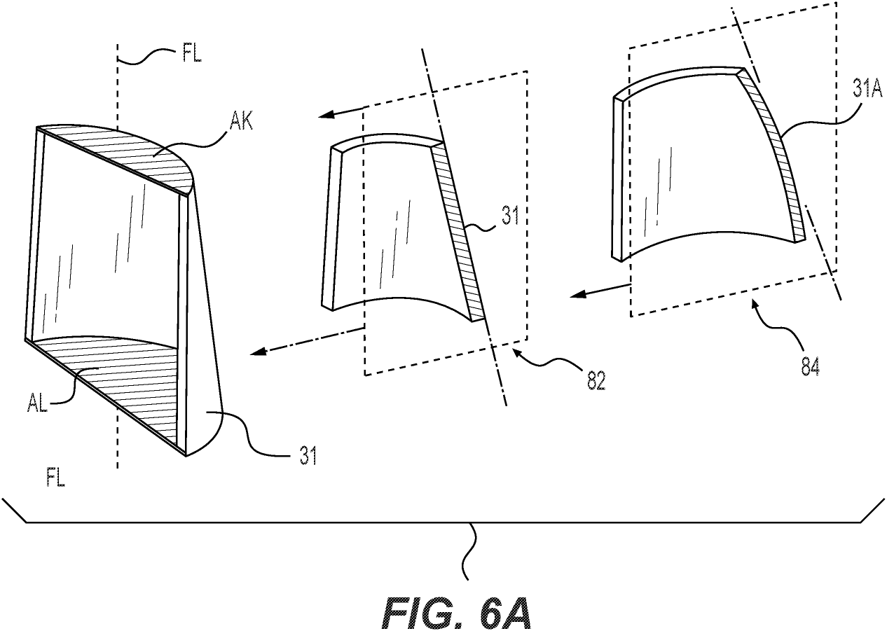

In another embodiment, the side of the endwall may run upwardly along a gently-curving path, then may blend into the endwall top surface at a sharp curve thereof. The intersection of such a gently-curving endwall side of a vertical centerplane of the half tank may be a curved line. Thus, it may be said that in the latter instance that the side has the shape of a portion of an imaginary curved-cone frustrum as depicted in FIG. 6A.

An endwall having the foregoing invention combination of features and configuration provides a septic tank with surprisingly good strength and resistance to deformation. When the septic tank comprises a vertical brace on the inner edge of the ring of an upper half tank, tilting of the ring is minimal.

The features and advantages of the present invention will become apparent from the following description of embodiments and accompanying drawings.

### BRIEF DESCRIPTION OF THE DRAWINGSS

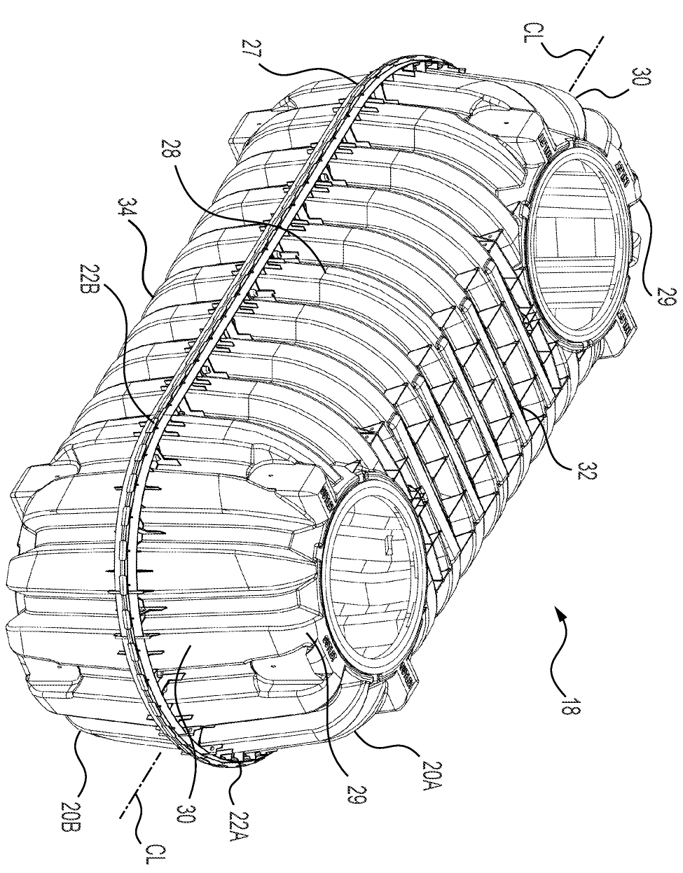

FIG. 1 illustrates a perspective view of a septic tank formed of two half tanks mated at a joint between respective joint flanges, consistent with embodiments of this disclosure.

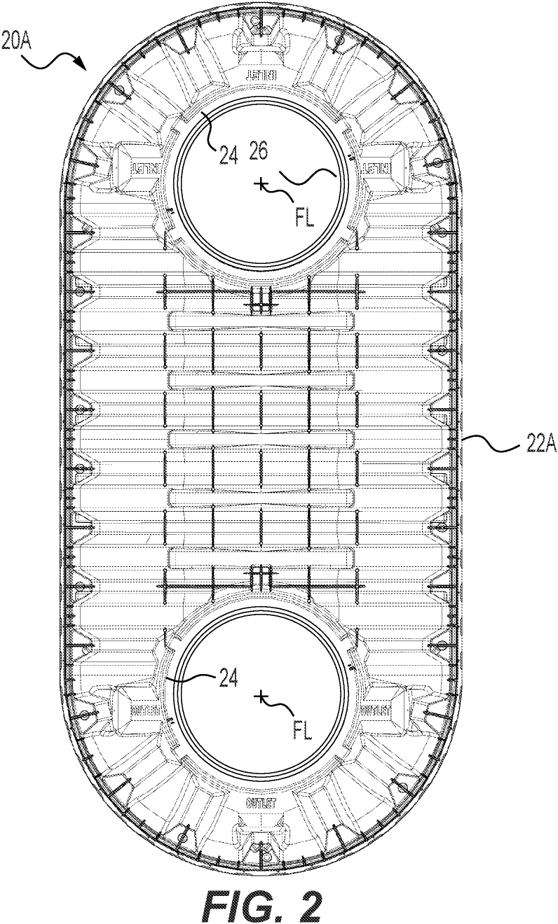

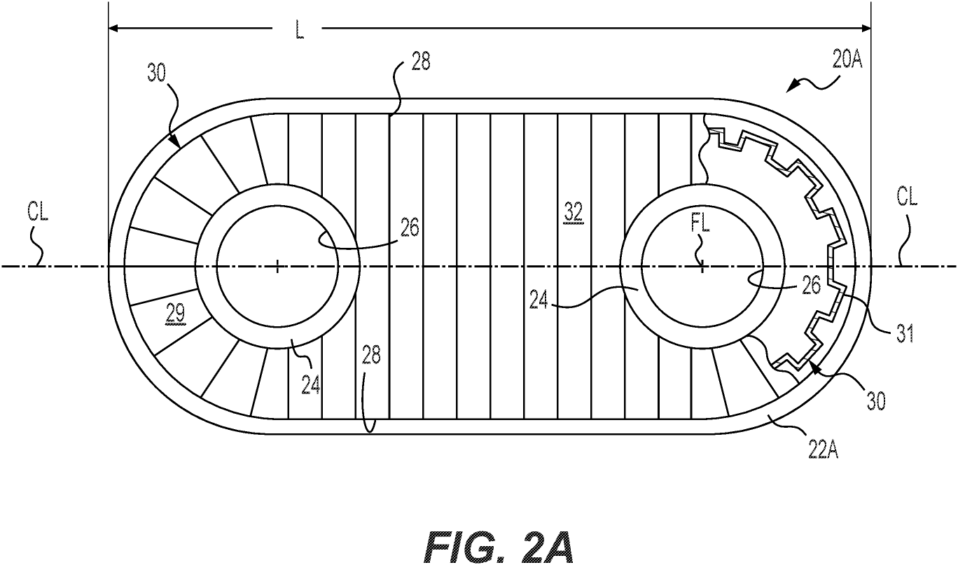

FIG. 2 illustrates a top view of a half tank that is useful as the upper half tank of a septic tank, consistent with embodiments of this disclosure.

FIG. 2A illustrates a simplified top view of the half tank of FIG. 2 with a partial cutaway, consistent with embodiments of this disclosure.

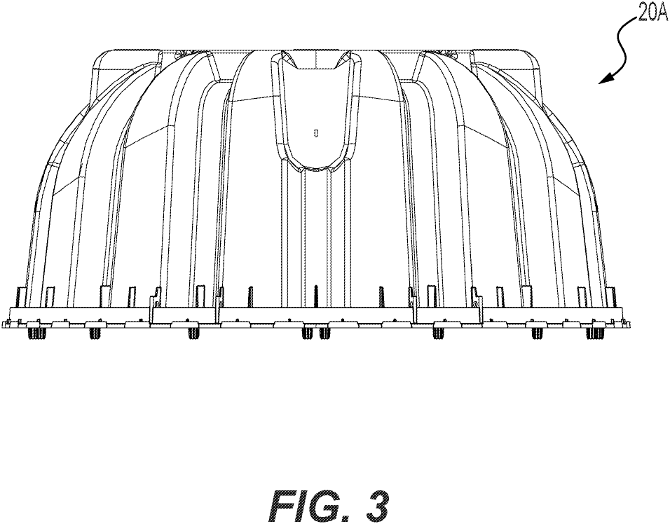

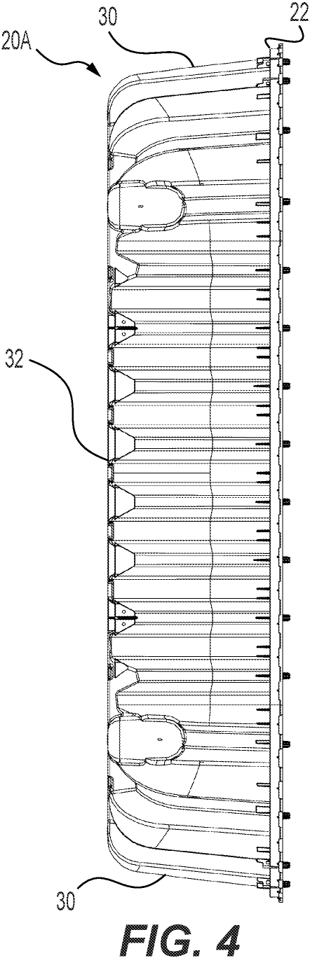

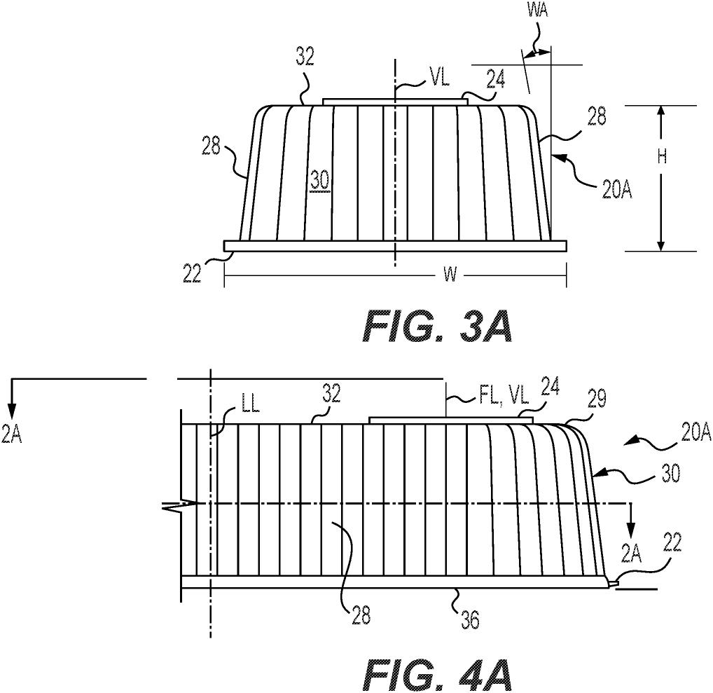

FIG. 3 illustrates an end view of the half tank of FIG. 2, consistent with embodiments of this disclosure.

FIG. 3A illustrates a simplified end view of the half tank of FIG. 2, consistent with embodiments of this disclosure.

FIG. 4 illustrates a side view of the half tank of FIG. 2, consistent with embodiments of this disclosure.

FIG. 4A illustrates a simplified side view of the half tank of FIG. 2, consistent with embodiments of this disclosure.

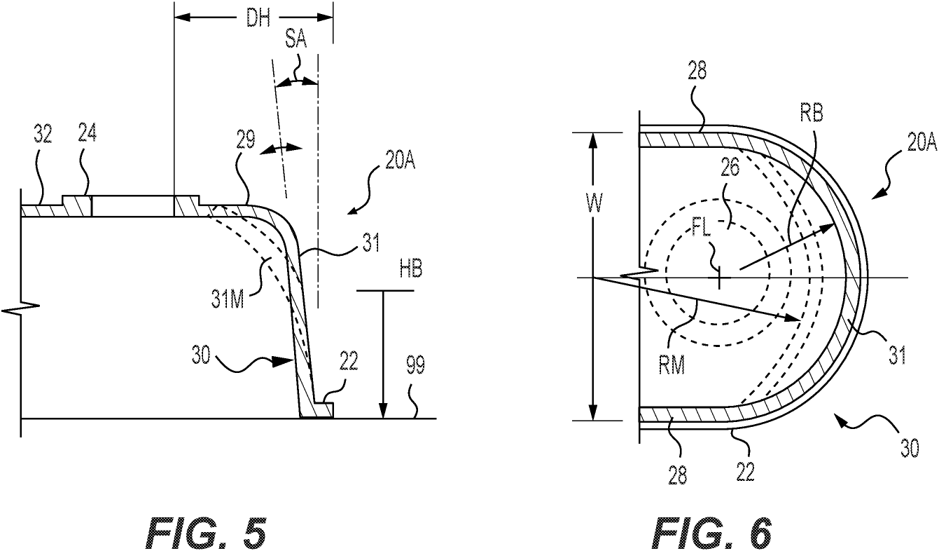

FIG. 5 illustrates a partial lengthwise centerplane view of the cross section of a half tank, consistent with embodiments of this disclosure.

FIG. 6 illustrates a partial cross section view of an upper half tank showing the lengthwise end at a plane that is just above the elevation of the joint flange, consistent with embodiments of this disclosure.

FIG. 6A illustrates a portion of an endwall to illustrate area and angle relationships, consistent with embodiments of this disclosure.

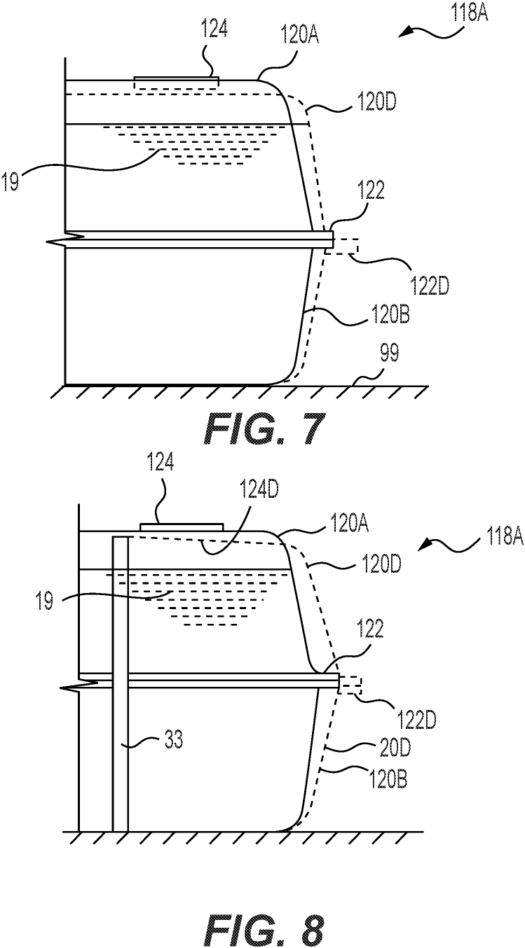

FIG. 7 illustrates a partial vertical centerplane cross section of a septic tank containing water.

FIG. 8 illustrates a partial vertical centerplane cross section of a septic tank containing water, wherein the tank has a brace at the inner edge of a ring in the top, consistent with embodiments of this disclosure.

FIG. 9 illustrates a perspective view of a prior art half tank.

FIG. 10 illustrates an end view of the half tank of FIG. 9

### DETAILED DESCRIPTION

Embodiments of tanks according to embodiments of the present disclosure may be made by molding polyolefin thermoplastics, such as polypropylene and polyethylene, in dies, preferably by compression or injection molding. Tanks may be alternatively made of other thermoplastics. The disclosures of U.S. Pat. 8,070,005 and U.S. Pat. No. 7,572,372 are hereby incorporated by reference.

The material of thermoplastic tanks according to embodiments of the present disclosure may comprise no fiber reinforcement. A typical polyethylene, for example, may have no fiber, a specific gravity of 0.91 to 0.93, a tensile strength of 34 MPa and a modulus of elasticity of 100 thousand psi.

Nonetheless, in some embodiments, short/chopped glass fibers of up to 3 mm (about 0.12 inch) length may be included in the thermoplastic which is injection or compression molded to form septic tanks as described herein. The properties of fiberglass materials are substantially different from those of thermoplastic polyethylene and polypropylene. Thus, the modulus of elasticity and fracture toughness of the product will be improved. As applied to large plastic tanks as described herein, the thermoplastic of the tank may comprise 5 to 30 weight percent glass fiber, providing a specific gravity of 1.7 to 2, a flexural strength of around 440 MPa, and a modulus of elasticity of 10.5 million psi.

As shown in the perspective view of FIG. 1 a septic tank 18 may be comprised of an upper half tank 20A and a lower half tank 20B that may be mated with each other at a joint 27 between respective joint flanges 22A, 22B. The half tank flanges 22 may be held to each other by clamps, and there may be a resilient seal between the mating flange surfaces. Other fasteners such as screws may be used, or adhesives or welding may be employed.

Each half tank 20A and 20B may have a multiplicity of corrugations for imparting strength to the walls. The corrugations may have a nominal depth of 3 inches where they are deepest. In the following description, when reference is made to the shape, orientation, or relative spacing of features of a half tank or whole tank, it will be understood that a reference is usually to the larger dimension of the corrugated wall, i.e., the external surface portions of the corrugations; sometimes it will be apparent that the reference is to the mean dimension of the wall.

An embodiment of upper half tank 20A is shown in FIGS. 2, 3 and 4, respectively in top view, end view, and side view. As shown in FIG. 2, at the top of the upper half tank 20A there may be two spaced apart integral rings 24, each ring circumscribing an access opening 26 to the tank interior. The integral rings 24 may provide a means for attaching a lid or riser to the top of the tank. A lower half tank may be identical to the upper half tank, except for that the space within each ring is solid and not an opening. In one embodiment of the manufacturing process, the upper half tank may be worked after molding to cut away the material within the ring and thereby create openings 26, whereas the lower half tank has not had material cut away.

The upper half tank 20A of FIGS. 2, 3, and 4 may be used as an upper half tank in a septic tank 18 when mated with a lower half tank 20B. As an example, a tank made of mated half tanks may be suited for holding and treating about 1000 gallons of wastewater. Such an exemplary tank has a maximum width that is about 62 inches, a maximum height that is about 55 inches and a maximum length that is about 134 inches. In an alternative embodiment, tank 18 may be fiberglass or thermoplastic that is molded of two half tanks which are bonded together, and therefore the half tanks are integral.

For convenience of description, and without thereby limiting the scope of claimed invention, an invention tank and its parts are described with reference to directions in a typical use-orientation, insofar as up and down, etc. Embodiment of the tank may be a one-piece tank or a two-piece tank. Two-piece tank embodiments may be used to exemplify the invention in this description. A two-piece tank may have a joint between the joint flange of an upper half tank and the joint flange of a lower half tank. The joint flanges may be fastened together with clamps, though other fasteners such as screws, bolts, or welding techniques may be used.

In an embodiment of a two-piece tank, the upper half tank and the lower half tank may be formed in the same mold by compression molding or injection molding. Thus, the joint between the half-tanks may be at mid-elevation of the tank. In an assembled tank, the mated joint flanges present as a belt circumscribing the tank. In other embodiments, the joint may be at locations other than mid-elevation, and the upper and lower half tanks may have different heights.

In some embodiments, a two-piece tank may have nominally the same configuration as the one-piece tank, with the exception that in place of the mated joint flanges there may alternatively be a circumscribing belt that is less substantial that the mated joint flanges of half tanks. In other embodiments there may be no circumscribing belt.

Referring again to FIG. 1, an exemplary two-piece tank may have an upper half 20A, a top and an associated top wall 32; a lower half 20B, a bottom and associated bottom wall 34 (largely hidden in FIG. 1). Opposing sidewalls 28, one of which is hidden in FIG. 1, may run curvingly from both the top wall 32 and the bottom wall 34 toward the midpoint joint at a slightly off-vertical angle. They are farthest apart at the joint or mid-elevation. Tank 18 may have opposing endwalls 30, two pairs, one pair on the upper half 20A and another pair on the lower half 20B. At each lengthwise end of the upper half tank 20A and the lower half tank 20B, an endwall 30 connects the opposing sidewalls 28. Endwall 30 may connect to ends of opposing sidewalls 28. Each endwall 30 may have a side portion that runs inwardly toward the interior of the tank 18. Each endwall 30 of the upper half 20A has a top 29 that is connected to the top wall of the tank. Likewise, the lower half tank 20B comprises associated endwalls 30 with analogous parts and features. Typically, there are access openings and circumscribing rings in the top of the tank, and the ring may be partially on the top of the endwall and partially on the top wall of the tank.

Some prior art molded plastic septic tanks made from mated half tanks generally had endwalls with sides that, in horizontal plane cross section at about halfway between the joint flange and the top, ran transverse to the length axis CL and were either nominally perpendicular to the length axis CL or followed a gentle curve of large radius.

In developing the present disclosure, it was found that carefully shaping the endwalls of a two-piece septic tank could provide a surprisingly large benefit. That benefit can be appreciated by understanding the tank behavior that was being dealt with, namely the way in which the tank deforms during testing or use.

FIG. 7 shows a tank 118A comprised of upper half tank 120A that does not have the features described below. Upper half tank 120A and lower half tank 120B are mated at joint flanges 122. The tank is shown as it sits on a planar surface 99. The weight of water 19 within the tank causes the tank to deform outwardly, as illustrated by the phantom endwall 120D. That causes flange 122 to move downwardly and outwardly as illustrated by phantom flange 122D.

As depicted in FIG. 8, a tank 118A may have internal bracing to help resist vertical loads. FIG. 8 shows the embodiment of that tank depicted in FIG. 7, but in FIG. 8, tank 118A includes brace 33 that extends vertically from the bottom of the tank to the tank top adjacent ring 124. An example of a brace is a two-inch square hollow cross section fiberglass pole, but other suitable braces may also be employed. The purpose of brace 33 and the like (which is common in large elongated molded plastic septic tanks) is to provide structural support to the top of the septic tank during use, when the top may be subject to the load of overlying soil, snow, or vehicles and the like.

When the tank 118A having a brace 33 contains water 19, the tank distorts much as it did without the brace. But as shown in FIG. 8 the phantom ring 124D may be tilted, because the ring inner edge has support from brace 33 while the ring edge nearer the phantom endwall 120D does not. A tank set in an excavation in soil where the backfill is not well-tamped around the tank likely behaves in much the same fashion as shown in FIG. 8. Because a riser that is often attached to a tilted ring typically projects above the ground surface, resultant riser tilting is undesirable. Tilting could suggest there is strain and possible permanent deformation of the tank. Thus, an object of the present disclosure is to eliminate such tilting in a tank that has an internal brace.

FIGS. 2A, 3A, and 4A are simplified versions respectively of FIGS. 2, 3, and 4. FIG. 2A shows an embodiment of half tank 20A in top view (which also may be called plan view) with partial cutaway of the top wall 32. Half tank 20A has a central longitudinal axis CL. FIG. 3A shows half tank 20A in end view along with vertical axis VL. FIG. 4A shows half tank 20A from the side view (also called elevation view).

Half tank 20A has opposing side walls 28, opposing endwalls 30, and a top 32. A two-piece corrugated wall plastic half tank 20A has a horizontal centerplane and a vertical centerplane containing lengthwise axis CL. The half tank 20A has an overall width W, an overall length L, and an overall height H. Half tank 20A may have two spaced apart rings 24 circumscribing openings 26. The opposing sidewalls 28 may slope curvingly inward toward the tank interior with distance from joint flange 22 (sometimes called the base flange of the half tank). Each joint flange 22 may have a faying surface 36 which mates with the faying surface of a mating half tank. Faying surface 36 may also be characterized as lying along a joint plane or base plane. The side walls may be generally equidistant from a vertical centerplane containing centerline CL.

In an embodiment, upper half tank 20A may comprise a substantially flat top wall 32, opposing lengthwise-extending sidewalls 28 running from the top wall to joint flange 22, and opposing endwalls 30. Each sidewall 28 may slope in a direction where the lower end is closer to the interior than the upper end, illustrated by angle WA in FIG. 3A.

FIG. 5. and FIG. 6 depict an embodiment of endwall 30. In some embodiments, each opposing endwall 30 in a tank may be identical. An endwall 30 may include a portion of joint flange 22. An endwall 30 may have a top 29 that is integral with the top wall of the half tank. In an embodiment, the top 29 may be curved. Endwall 30 may have a vertical slant, and in some embodiments, may cant or slope inwardly. The outer periphery of an endwall top 29 may curve abruptly in the direction of endwall side 31 and may be integral with side 31, which runs both generally vertically and in arc-like fashion, connecting the ends of the sidewalls 28.

An endwall side 31 runs upwardly from the joint flange 22 with an incline that is in the direction of the tank interior. Thus, with reference to FIG. 6A, the area AK that is encompassed within the generally C shape of the endwall side at the top of the endwall is smaller than the area AL that is encompassed within the generally C shape of the endwall side that is adjacent to the joint flange 22 (not shown in FIG. 6A).

FIG. 5 and FIG. 6 illustrate parameters of embodiments of the endwall 30. FIG. 5 is a partial lengthwise centerplane cross section of half tank 20A, which is shown with the base flange 22 faying surface lying on plane 99. The endwall side 31 of an embodiment of endwall 30 may run upwardly from the joint flange 22 at an angle SA to the vertical. In an embodiment, SA may be about 7 degrees. In other embodiments, angle SA may be between 3 and 9 degrees. FIG. 5 is discussed further below.

FIG. 6 is a top view of a partial lengthwise cross section of the end of an example of upper half tank 20A of FIG. 5, where the horizontal cross section plane is cut just above the joint flange 22. Ring 26 and ring vertical axis FL are shown in phantom for reference. In variations of the embodiments depicted in FIG. 2A and FIG. 6, the ring may be closer to or further from the endwall than shown in FIG. 6 and FIG. 2A.

In some embodiments, the endwall side 31 of the endwall 30 of a half tank may be a portion of a frustum of a cone centered on axis FL, which in an embodiment is the vertical axis about which the ring is centered. The base of the cone just above the flange joint 22 has a radius RB. An exemplary dimension of radius RB is half the width W of the half tank. Because of the geometry of the curved surface of endwall side 31, the radius of the cone decreases towards the top 29 compared to the radius at the joint flange 22. At any elevation between the top 29 and the flange 22, the radius has the same fractional relationship to the width at that elevation, i.e., being about equal to one half of the width of the half tank at said elevation.

In an embodiment, the conical segment of endwall side 31 of endwall 30 is blended with and integral with the side walls 28 as shown in FIG. 6. In some embodiments, the endwall 30 comprises a conical segment having radii which are greater than half the width W of the half tank. For example, the radius RM shown in FIG. 6 may be in the range of greater than 0.5 W to about 0.65 W. Higher ratios give the tank more volume compared to alternative embodiments, with other parameters being unchanged. In those alternative embodiments, the endwall side 31 of endwall 30 will not necessarily blend smoothly into the sidewalls.

In an embodiment, at least a portion of the endwall 30 has the shape of a portion of the frustum of a cone that has a taper relative to the vertical axis of the cone of 3 to 9 degrees, and in one embodiment may be 7 degrees.

FIG. 6A depicts two different representations, 82 and 84, of a portion of the vertical centerplane that are “extracted” from their true position for purpose of illustrative convenience and clarity. Plane segments 82 and 84 respectively “cut through” an endwall conical endwall side 31 and 31A. In plane 82, the conical shape endwall side 31 is “perfect” in the sense that it lies along a straight line with constant incline. In plane 84, the side 31A of an endwall has a curved conical shape and thus as a cone, the side is “imperfect” because the intercept of side 31A with plane 84 is a curved line. (A cone by definition is “perfect.” A “curved cone” is a term of art used here.)

In some embodiments, the lower portion of the side may be a perfect conical portion and the upper portion of endwall side 31 may an imperfect conical segment, curving inwardly. In FIG. 5, phantom side 31M shows how at elevation HB, the segment of a “perfect cone” shape transitions to a segment of an “imperfect cone.” In an embodiment, the endwall side 31 runs along a curve which is a semi-circle, or a portion thereof, and in a vertical plane, includes an inward slant from the upper half tank flange 22 to the endwall top 29. The inward slant may be a straight line or it may be a curve having a radius of greater than one half the width of the upper half tank 20A, or the inward slant may be a combination of a straight line and a curve having a radius of greater than one half the width of the upper half tank 20A.

The present disclosure contrasts with prior art tanks formed of mating half-tanks, one of which is shown in FIG. 9 and FIG. 10. Upper half tank 70 has an endwall 72 that, in the horizontal plane near the base flange 74, curves with a radius R that is greater than the tank width W. The side wall 76 of the half tank runs upwardly from the joint flange along a straight inward tilted path, and then along a substantially curved path, as shown in FIG. 10. A septic tank of the present disclosure that comprises a unique endwall feature, an embodiment of which is described as endwall 30, may be a somewhat longer tank than a comparable volume tank made with half tank 70 and a mating lower half tank of the same dimensions. This maintains storage volume at minimal cost of material.

Embodiments of the present disclosure may include:

A septic tank, configured for holding at least 1000 gallons of wastewater, made of polypropylene or polyethylene thermoplastic, the tank having a first lengthwise end, an opposing second lengthwise end, a top, a bottom, a horizontal centerplane, and a vertical lengthwise centerplane, a basic wall thickness T.

The septic tank may comprise an upper half tank having corrugated walls and an oblong flange lying nominally in said horizontal centerplane, the flange having substantially straight lengthwise sides spaced apart a distance W and ends spaced apart a distance L and, a lower half tank having corrugated walls and an oblong flange lying nominally in said horizontal centerplane, the flange having substantially straight lengthwise sides spaced apart said distance W and lengthwise ends spaced apart said distance L; Other features of the septic tank may include:
wherein the upper half tank oblong flange and the lower half tank oblong flange are either integral with each other or are secured to each other along said horizontal centerplane by one or more of fasteners, clamps or adhesives;
wherein, the upper half tank further comprises a top wall that runs substantially parallel to said horizontal centerplane, a first sidewall and a second sidewall,
wherein the sidewalls are spaced apart equally from the vertical centerplane, each sidewall running lengthwise from a first sidewall end in proximity of the first end of the tank to a second sidewall end in proximity of the second end of the tank, and each sidewall running vertically from said upper half tank oblong flange to the top wall along a path that is inclined inwardly toward the vertical centerplane, opposing endwalls, each endwall integrally connecting an end of the first sidewall to an end of the second sidewall,
wherein each end wall comprises: an endwall top, an endwall side running from the upper half tank flange to the endwall top along an inward slant,
wherein, the endwall top is contiguous with said upper half tank top wall,
wherein, the endwall side runs along a curve which is a semi-circle or a portion of a curve, and
wherein, in a vertical plane, said inward slant runs along a path which is either a straight line or a curve having a radius of greater than one half distance W or a combination of said straight line and said curve having a radius of greater than one half distance W.

Additional embodiments of the present disclosure may include:
wherein the upper half tank endwall side connects to the endwall flange along a path that is a semi-circle having a radius between 0.5 and 0.65 of distance W.
wherein the endwall side is shaped as a portion of a frustum of a cone.
wherein the slant of the endwall side runs along a substantially straight line in the vertical center plane.
wherein said straight line has an angle of incline with a transverse vertical plane of the tank of between 5 degrees and 9 degrees
wherein said straight line has an angle of incline with a transverse vertical plane of the tank of 7 degrees.
wherein the inward slant runs along a path which has a radius RR that is greater than 0.82 W.
wherein the basic wall thickness is about 0.200 inch and the wall thicknesses in the tank are no more than 10 percent greater or less than the basic wall thickness.
wherein the wall thicknesses in the tank are no more than 15 percent greater or less than the basic wall thickness.
wherein the polypropylene or polyethylene thermoplastic includes up to 30 weight percent of randomly oriented chopped glass fiber.

Thus, a septic tank, having a tank comprising joined together half tanks, has improved strength as a result of the new endwall configuration that comprises a unique combination of related features that have been described. The improvements described herein may be used with tanks other than septic tanks, for example liquid storage tanks.

Explicit and implicit variations and advantages have been described and illustrated with respect to several exemplary embodiments. Those embodiments should be considered illustrative and not restrictive examples. Various changes, omissions and/or additions may be made. Persons skilled in the art may make various changes in form and detail of the embodiments which are described. Modifications and adaptations of the embodiments will be apparent from consideration of the specification and practice of the disclosed embodiments. For example, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations and/or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps and/or inserting or deleting steps.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and, accordingly, all suitable modifications and equivalents may be resorted to, falling within the scope of the disclosure.

What is claimed is:

1. A septic tank made of polypropylene or polyethylene thermoplastic, the tank having a first lengthwise end, an opposing second lengthwise end, a top, a bottom, a horizontal centerplane, a vertical lengthwise centerplane, and a basic wall thickness T, the septic tank comprising:
an upper half tank having corrugated walls and an oblong flange lying nominally in the horizontal centerplane, the flange having substantially straight lengthwise sides spaced apart a distance W and ends spaced apart a distance L; and,
a lower half tank having corrugated walls and an oblong flange lying nominally in the horizontal centerplane, the flange having substantially straight lengthwise sides spaced apart the distance W and lengthwise ends spaced apart the distance L;
wherein the upper half tank oblong flange and the lower half tank oblong flange are either integral with each other or are secured to each other along the horizontal centerplane by one or more of fasteners, clamps or adhesives; wherein,
the upper half tank further comprises:
a top wall that runs substantially parallel to the horizontal centerplane,
a first sidewall and a second sidewall, the sidewalls spaced apart equally from the vertical centerplane, each sidewall running lengthwise from a first sidewall end in proximity of the first end of the tank to a second sidewall end in proximity of the second end of the tank, and each sidewall running vertically from the upper half tank oblong flange to the top wall along a path that is inclined inwardly toward the vertical centerplane, and,
opposing endwalls, each endwall integrally connecting an end of the first sidewall to an end of the second sidewall,
wherein each end wall comprises:
an endwall top,
an endwall side running from the upper half tank flange to the endwall top along an inward slant,
wherein, the endwall top is contiguous with the upper half tank top wall,
wherein, the endwall side runs along a curve which is a semi-circle or a portion of a curve, and
wherein, in a vertical plane, the inward slant runs along a path which is either a straight line or a curve having a radius of greater than one half distance W or a combination of the straight line and the curve having a radius of greater than one half distance W.

2. The tank of claim 1, wherein the upper half tank endwall side connects to the endwall flange along a path that is a semi-circle having a radius between 0.5 and 0.65 of distance W.

3. The tank of claim 1, wherein the endwall side is shaped as a portion of a frustum of a cone.

4. The tank of claim 2, wherein the endwall side is shaped as a portion of a frustum of a cone.

5. The tank of claim 1, wherein the slant of the endwall side runs along a substantially straight line in the vertical center plane.

6. The tank of claim 5, wherein the straight line has an angle of incline with a transverse vertical plane of the tank of between 5 degrees and 9 degrees.

7. The tank of claim 5, wherein the straight line has an angle of incline with a transverse vertical plane of the tank of 7 degrees.

8. The tank of claim 1, wherein the inward slant runs along a path which has a radius RR that is greater than 0.82 W.

9. The tank of claim 1, wherein the basic wall thickness is about 0.200 inch and the wall thicknesses in the tank are no more than 10 percent greater or less than the basic wall thickness.

10. The tank of claim 9, wherein the wall thicknesses the wall thicknesses in the tank are no more than 15 percent greater or less than the basic wall thickness.

11. The tank of claim 1, wherein the polypropylene or polyethylene thermoplastic includes randomly oriented chopped glass fibers, wherein the weight percent of randomly oriented chopped glass fibers is up to 30.

12. The tank of claim 1, wherein the tank is configured for holding at least 1000 gallons of wastewater.

13. The tank of claim 11, wherein the chopped glass fibers have a length of 3 mm or less.
